(19) United States
(12) Patent Application Publication
(10) Pub. No.: US 2002/0199210 A1
(43) Pub. Date: Dec. 26, 2002

(54) Universal test meter for digital signal distribution systems

(76) Inventors: Pingnan Shi, Greenwood, IN (US); Eric M. Sadowski, Indianapolis, IN (US)

Correspondence Address: Harold C. Moore, Maginot, Addison & Moore, Bank One Center/Tower, 111 Monument Circle, Suite 3000, Indianapolis, IN, 46204-5115, US

(21) Appl. No.: 09/891,886

(22) Filed: Jun. 26, 2001

(51) Int. Cl. H04N 7/16

(52) U.S. Cl. 725/144; 725/148

(57) ABSTRACT

A test meter for digital CATV systems is operative to analyze digital CATV signals or channels utilizing selectable signal conditioning circuits, depending on the format of the CATV signal under test. The test meter is thus operative to analyze digital CATV signals transmitted according to various international digital standards. In one form, the signal conditioning circuits include SAW filters for particular bandwidths according to the digital signal standard of the particular CATV system. The SAW filters correspond to the bandwidths associated with a particular digital signal standard. Once the signal conditioning circuit has been selected, an output of a corresponding filter is input to a digital decoder circuit such as a QAM decoder. The QAM decoder is operative to decode all three (3) international QAM standards in accordance with ITU-T J.83 for digital signals. The test meter is operative to analyze various signal parameters and is preferably under control of a processing unit and a graphical user interface.

### FIELD OF THE INVENTION

The present invention relates to meters for testing digital signal distribution systems and, more particularly, to an adaptable meter for testing digital cable systems utilizing different transmission/encoding standards and/or formats.

### DESCRIPTION OF THE PRIOR ART

Cable television systems, often denoted CATV systems, are comprised of many miles of coaxial cable strung about a service area with amplifiers and other elements interspersed throughout as necessary. The CATV system carries a number of channels of television programming that typically include both audio and video information. The CATV system may carry analog signals, digital signals, and/or a combination of analog and digital signals. As well, supplemental information, such as closed captioning information and/or V-chip (rating) information may also be broadcast over a channel, with each channel having a unique channel frequency. Subscribers to the CATV system are connected to the coaxial cable system, with the coaxial cable coupled to one or more televisions in the subscriber's home.

In addition to television signals and supplemental information, the CATV system may also carry return path data originated by set-top boxes (i.e. cable boxes, satellite boxes, etc.) in a subscriber's home. As well, the CATV system may carry cable modem signals/data. The CATV system may carry other signals/data that may be analog and/or digital.

The CATV system transmits each channel over a predefined frequency range or bandwidth. The bandwidth allotted for each channel depends on the location of the CATV system. In North America, each channel must carry its audio and video data/information over a six-megahertz (6 MHz) bandwidth. For other countries, the same channel data need only fit into a seven or eight megahertz (7 or 8 MHz) bandwidth. Other countries or areas may have different bandwidths. Digital and/or analog signals from set-top boxes, cable modems and the like are typically carried by the distribution system over particular and various ranges of frequencies and/or bandwidths.

In the case of digital signals, the digital information or data is encoded using one of various types of modulation or encoding schemes such as QAM (Quadrature Amplitude Modulation), VSB (Vestigal SideBand), or the like. Thus, a CATV system in a particular region will typically use one type of encoding within a particular bandwidth.

It is periodically necessary to conduct tests upon a CATV system (i.e. the analog and/or digital televisions signal(s) of the CATV system) in order to perform routine maintenance, to ascertain problems such as signal ingress and egress, to upgrade the CATV system, and the like. In order to test a particular digital channel, frequency, and/or frequency band of a particular CATV system and/or digital data, it is necessary to utilize a test meter operative to analyze digital signals. Such test meters, however, must be operative to analyze digital signals particular to the location of the CATV system and the type of data encoding and/or modulation utilized. The type of digital data encoding and/or modulation is typically governed by a digital standard of any number of digital standards.

Since there are various digital standards around the world, manufacturers of digital signal test meters have heretofore had to produce a different test meter for each type of CATV system. In particular, and as an exemplary case with regard to digital signals, a test meter for North America CATV systems typically needs to ascertain 6 MHz channel bandwidths and QAM encoding, while a test meter for European CATV systems typically needs to ascertain 7-8 MHz channel bandwidths and QAM encoding. As well, within a particular type of digital encoding (i.e. QAM) there are variations such as 64-QAM, 256-QAM, and the like.

What is therefore needed is a test meter that can be used to analyze a digital signal irrespective of the encoding format and/or standard of the digital television signal.

What is further needed is a test meter that can be used to analyze a digital signal carried by a digital signal distribution network regardless of the encoding format and/or digital standard used by the digital signal distribution network.

What is still further needed is a test meter that is operative to analyze digital television signals carried by a digital cable television system irrespective of the local television standard and digital modulation technique utilized by the digital cable television system.

### SUMMARY OF THE INVENTION

The present invention is a test meter for a digital signal distribution network that is operative to analyze digital signals such as television/entertainment and/or data signals transmitted according to various international digital standards.

Particularly, the present invention is directed to a test meter for digital cable distribution system that is operative to analyze parameters of digital signals that have been encoded according to various international digital encoding standards.

More particularly, the present invention is directed to a test meter for digital cable television systems (digital CATV) that is operative to analyze various parameters of a digital television/data signal that has been encoded according to any one of a plurality of digital modulation techniques and transmitted according to any one of a plurality of digital standards.

In one form, the present invention is directed to a test meter for a digital signal distribution system. The test meter includes a front end, digital signal conditioning circuitry in communication with the front end, and a digital demodulator in communication with the digital signal conditioning circuitry. The front end is operative to acquire a digital signal carried by the digital signal distribution system. The signal conditioning circuitry receives the digitally encoded signal acquired by the front end and is operative to apply signal conditioning to the digital signal according to any one of various digital standards(e.g. international digital encoding standards). The digital demodulator receives the digital standard conditioned signal (digital standard signal) from the signal conditioning circuitry and is operative to apply any one of various digital demodulation decoding schemes to obtain a demodulated signal.

In another form, the present invention is directed to a test meter for a digital cable television/entertainment/data system (collectively, “digital cable television system” or “digital CATV system”). The digital CATV system carries collectively digital television signals (encompassing digital television and data signals). The test meter includes a front end, digital signal conditioning circuitry in communication with the front end, a digital demodulator in communication with the signal conditioning circuitry, and selection circuitry in communication with the signal conditioning circuitry and the digital demodulator. The front end is operative to obtain a digital television signal from a point in the digital CATV system. The signal conditioning circuitry receives the obtained digital television signal from the front end and is operative to selectively apply signal conditioning to the obtained digital television signal according to any one of multiple digital standards to obtain a digital standard signal. The digital demodulator receives the digital standard signal from the signal conditioning circuitry and is operative to selectively apply any one of multiple digital demodulation schemes to obtain a demodulated signal. The selection circuitry is operative to select a digital standard of the multiple digital standards for application by the signal conditioning circuitry and to select a digital demodulation scheme of the multiple digital demodulation schemes for application by the digital demodulator.

In yet another form, the present invention is a method of analyzing a digital signal carried by a digital signal distribution system. The method includes: (a) coupling a test meter to a point in the digital signal distribution system; (b) obtaining via the test meter a digital signal carried by the digital signal distribution system; (c) selecting via the test meter a digital encoding standard from multiple digital standards to apply to the obtained digital signal; (d) applying via the test meter the selected digital standard to the signal to obtain a digital standard signal; (e) selecting via the test meter a demodulation scheme from multiple demodulation schemes to apply to the digital standard signal; and (f) applying via the meter the selected demodulation scheme to the digital standard signal to obtain a demodulated signal for analyzing various parameters of the digital signal.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram representation of a digital signal distribution system such as a CATV system of the type in which the present invention may be used;

FIG. 2 is a block diagram representation of an exemplary test meter in accordance with the principles presented herein coupled to a point in a digital CATV system;

FIG. 3 is a block diagram representation of an exemplary test meter in accordance with the principles presented herein coupled to an RF input from a digital CATV system;

FIG. 4 is a block diagram of an exemplary test meter in accordance with the principles presented herein coupled to an RF input from a digital CATV system;

FIG. 5 is a block diagram of an exemplary test meter coupled to an RF input from a digital CATV system; and

FIG. 6 is a flow diagram of an exemplary manner of operation of a test meter in accordance with the principles presented herein.

Corresponding reference characters indicate corresponding parts throughout the several views.

### DETAILED DESCRIPTION

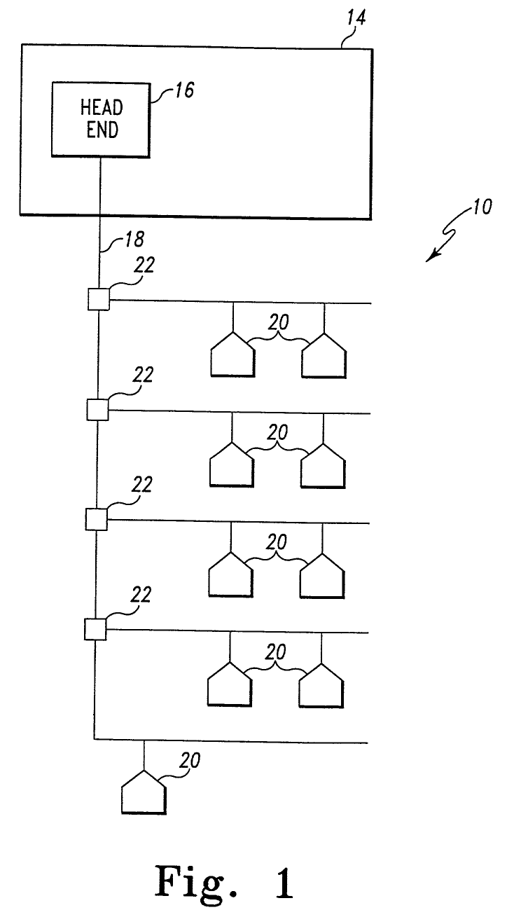

With reference now to FIG. 1, there is depicted a block diagram representation of a digital signal distribution system or network, generally designated 10. The digital signal distribution system 10 represents any same or similar system anywhere in the world. Particularly, the digital signal distribution system 10 represents a digital television, entertainment, and data signal distribution system. More particularly, the digital signal distribution system 10 represents a digital cable television (CATV) system that distributes digital television and/or entertainment signals and data signals (collectively, digital signals) via coaxial cable, fiber-optic cable, hybrid coaxial-fiber cable, and/or the like. Hereinafter, without limitation, the digital signal distribution system 10 will be referred to as a CATV system 10 (the CATV system may carry both digital and analog signals, or it may carry just digital signals).

The CATV system 10 thus provides at least one television channel or signal that is digital (i.e. digital television or digital signal) typically from a plurality of television channels or signals of a particular frequency or bandwidth (hereinafter collectively, without limitation, channel). The CATV system 10 may be considered a digital CATV system where at least one signal or channel is digital. The digital encoding for the digital television channel is typically in an MPEG (Motion Pictures Expert Group) format, while the digital modulation scheme may be any one of various types of digital modulation schemes such as Vestigal SideBand (VSB) or Quadrature Amplitude Modulation (QAM) and their variations or variants (e.g. 4-VSB, 8-VSB, 64-QAM, and 256-QAM), and the like. The CATV system 10 also may provide digital cable modem signals, digital entertainment signals, and the like (hereinafer, collectively digital television signals).

The CATV system 10 may provide all television channels in digital. The CATV system 10 may also include analog and/or a combination of analog and digital television channels. As well, the CATV system 10 is operative to provide other services such as interactive television, cable modem, and the like (collectively television signals). However, as used herein, the term television channel includes all such television signals.

A television channel includes television signals of a particular frequency and its useful frequency components (range of frequencies) or bandwidth of the television channel. The bandwidth of each television channel is determined by the particular video standard in use where the CATV system 10 is located. For analog television signals the video standard may be NTSC, PAL, SECAM, a variation of one of the aforementioned three standards, or another type (composite color television standards). The bandwidth of an NTSC television channel is six megahertz (6 MHz), while the bandwidth of a PAL television channel is greater than the NTSC television channel (i.e. typically 7 or 8 MHz). The NTSC standard is in use in the United States and the rest of North America, and Japan, while most of Europe, Australia, and other areas use PAL.

In the case of digital television signals, the digital television signal of the television channel is typically encoded according to a compression algorithm (e.g. MPEG) before transmission. Regardless of whether the digital television signal is compressed or the like, the digital television signal is modulated according to a digital modulation scheme or technique such as QAM and its variants, USB and its variants, QPSK and its variants, or the like, for transmission. In addition, the digital modulated signal is transmitted according to a digital standard such as ITU-T J.83. The ITU-T J.83 digital standard provides or specifies bandwidth, symbol rate, error correction coding and the like for various locales. Specifically, ITU-T J.83 includes an Annex A that specifies a digital standard for Europe, an Annex B that specifies a digital standard for the United States and Canada, and an Annex C that specifies a digital standard for Japan. Annex A specifies a bandwidth of 7 or 8 MHz while Annex B specifies a bandwidth of 6 MHz.

The cable system 10 includes a cable head end facility 14 at which a head end 16 of the cable system 10 is located. A coaxial cable 18 extends from the head end 16 throughout the area served by the cable system 10. Of course, transmission lines or conduits other than coaxial cable may be used and are thus encompassed herein under the term “coaxial cable.” Subscribers 20 are connected to the coaxial cable 18 at multiple points along its run. Interspersed throughout the run of coaxial cable 18 are various elements as are known in the art, such as amplifiers 22, which are part of the cable system 10.

As is conventional, the head end 16 receives a plurality of television signals, such as from satellite receivers (not shown) and antennas (not shown) located at the head end facility 14. The head end facility 14 converts the plurality of television signals to appropriate frequencies for transmission over the coaxial cable 18 to the subscribers 20. As an example, the cable system 10 might be designed to handle forty channels, each of which has a unique frequency or frequency range (bandwidth) carrying audio and video information. Other information may be carried by the television signal.

The television signals transmitted by the head end 16 generally consist of analog, digital, or a combination of analog and digital audio and video signals. In the case of digital television signals, of which the present invention is concerned, the digital audio and video bitstreams or information are converted into analog signals for transmission over the coaxial cable 18. This is accomplished by applying a digital modulation scheme representing the audio and video bitstreams or information onto a radio frequency (RF) carrier. The audio and video television information is transmitted via a digital. modulation scheme or technique. The digital modulation technique, for example, may be quadrature amplitude modulation (QAM), quadrature/quaternary phase shift keying (QPSK), vestigal sideband (VSB), or the like. Other types of digital modulation schemes may also be used as well as variations or variants of the above-mentioned digital modulation schemes (e.g. 16-QAM, 32-QAM, 64-QAM, 256-QAM, 4-VSB, and 8-VSB) and others. As well, different digital modulation schemes may be used for different channels of the CATV system depending on the type of data being transmitted. Depending on the geographic area of the CATV system 10, the analog television signals are also formatted for one of the particular television standards (i.e. composite color standards NTSC, PAL, SECAM).

At various points along the coaxial cable 18 of the CATV system 10, the CATV signal and/or the frequency response of the various channels, and/or other parameters may be tested and/or measured. The CATV channels may use analog and/or digital modulation schemes to transmit the televisions signals and/or other information therewith. A CATV test meter typically accomplishes the testing and/or measurement of the analog and digital channels.

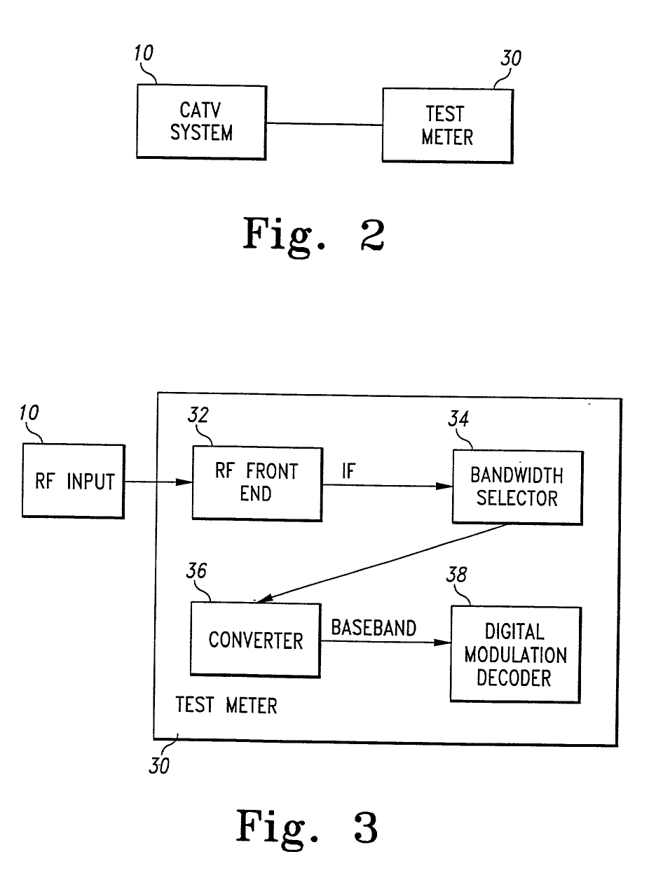

Referring to FIG. 2, there is illustrated an exemplary test meter made in accordance with the principles presented herein, generally designated 30, that is utilized to test digital CATV signals of the CATV system 10. Particularly, the test meter 30 of FIG. 2 is operative to test one or more digital CATV signals in any CATV system wherever the CATV system is geographically located, such as the CATV system 10. More particularly, the test meter 30 is operative to test and/or analyze various parameters of a digital television signal/channel of a CATV system 10 irrespective/regardless of the television format/standard, the digital encoding format/standard, and/or the digital modulation format/standard, and/or the digital standard or digital transmission standard utilized.

Referring to FIG. 3, there is shown a block diagram of various components of the test meter 30 coupled to the CATV system 10 so as to receive radio frequency (RF) input. The test meter 30 is configured/operative to be coupled to/at any point along the CATV system 10 and receive RF signals therefrom. The RF input signal may be any CATV channel or signal (test, television or otherwise) transmitted along the CATV system 10, but is particularly a digital CATV channel or signal such as cable modem data signals.

On an elementary level, the test meter 30 includes an RF front end module, section or portion 32 that is in communication with the RF input 10. A bandwidth or digital standard selector module, section or portion 34 is in communication with the RF front end 32 so as to receive an output (output signal) from the RF front end 32. A converter module, section or portion 36 is in communication with the bandwidth selector 34 so as to receive an output (output signal) from the bandwidth selector 34. The test meter 30 also includes a digital modulation decoder (digital demodulator) module, section or portion 38 that is in communication with the converter 36 so as to receive an output (output signal) from the converter 36. It should be appreciated that the converter 36 is optional, since the signal from the bandwidth selector 34 may be considered baseband, under a definition of baseband, and thus inputted directly to the digital modulation decoder 38.

The test meter 30 is thus operative to be coupled to a CATV system 10, select a particular digital television channel/signal, recover the digital information from the television channel/signal, and analyze various parameters of the digital signal and/or digital signal information. The test meter 30 analyzes the recovered digital information to obtain data such as MER, I/O data constellation, equalizer tap values, FEC readings, and the like that pertain to a digital television signal.

In particular, the RF front end 32 is operative via appropriate circuitry/logic to selectively receive any particular channel/signal of the RF input signal and down convert the selected channel/signal to an intermediate frequency (IF) signal. The IF signal is fed/input to the bandwidth or digital standard selector 34. The bandwidth selector 34 is operative via appropriate circuitry/logic to select an appropriate bandwidth (frequency range) of the useful components for the selected channel/signal. The appropriate bandwidth is according to the digital standard (i.e. ITU-T J.83 Annex A, Annex B, Annex C, etc., ) is being utilized by the CATV system 10. For an Annex B CATV system 10, the bandwidth is 6 MHz, while the bandwidth for a an Annex A CATV system 10 is 7 or 8 MHz. Once the appropriate bandwidth has been selected, which correlates to the appropriate digital standard (international digital encoding standard), an IF bandwidth output signal is fed or input into the converter 36 or directly to the digital modulation decoder 38.

The converter 36 is operative via appropriate circuitry/logic to convert the IF bandwidth output signal from the bandwidth selector 34 into a baseband signal (or alternatively worded, to recover the modulated information from a carrier component of the IF bandwidth output signal). The baseband signal from the converter 36 is fed or input into the digital modulation decoder (demodulator) 38.

The digital modulation decoder 38 is operative via appropriate circuitry/logic to selectively apply a demodulator or modulation decoder to recover the original digital television bitstream or information from the RF input signal. The digital demodulation decoder 38 is operative to apply a demodulator according to any one of various digital modulator schemes such as QAM, VSB, and QPSK, and their variants. The demodulator used by the demodulation circuitry/logic 38 depends on the modulation scheme employed by the CATV system under test. The receiver circuit 64 may include demodulation circuitry for all known types of modulation schemes for the digital channel. As well, the receiver circuit 64 may have only one type of demodulation circuitry for a specific type of modulation scheme and its variants. The test meter 30 thus demodulates the RF input signal to obtain a digital bitstream of the television channel. The digital bitstream includes both video and audio information (a composite bitstream), and any other secondary information (such as closed captioning or ratings information). Various parameters of the digital bitstream and/or the baseband signal may thus be analyzed. Cable modem data contains any data of various forms.

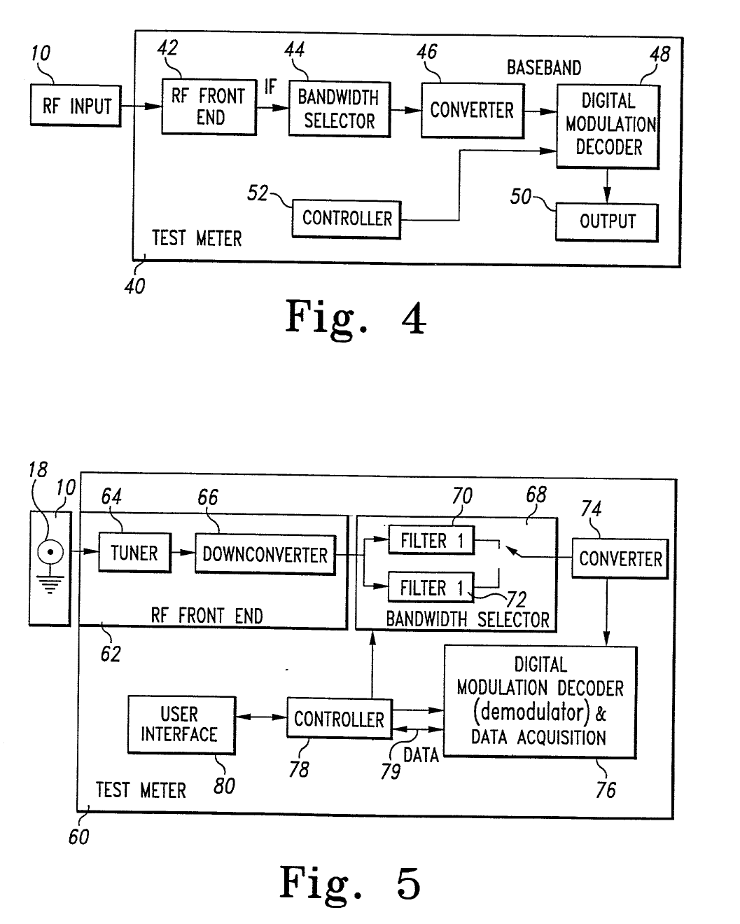

Referring to FIG. 4, there is depicted another embodiment of a test meter, generally designated 40, in accordance with the principles presented herein. The test meter 40 is operative to be coupled in like manner as the test meter 30 of FIG. 2. Particularly, the test meter 40 is operative to be coupled to or at a point in the CATV system 10 in order to obtain an RF input signal.

On an elementary level, the test meter 40 includes an RF front end module, section or portion 42 that is in communication with the RF input 10. A bandwidth or digital standard selector module, section or portion 44 is in communication with the RF front end 42 so as to receive an output (output signal) from the RF front end 42. A converter module, section or portion 46 may be in communication with the bandwidth selector 44 so as to receive an output (output signal) from the bandwidth selector 44 or the output of the bandwidth selector 44 may be coupled directly to a digital modulation decoder 48. The digital modulation decoder (digital demodulator) module, section or portion 48 is in communication with the converter 46 so as to receive an output (output signal) from the converter 46. An output module, section or portion 50 is in communication with the digital demodulator 48 so as to receive analyzed outputs from the digital demodulator 48. The test meter 40 is under control of a controller module, section or portion 52.

In particular, the RF front end 42 is operative via appropriate circuitry/logic to selectively receive any particular channel/signal of the RF input signal and down convert the selected channel/signal to an intermediate frequency (IF) signal. Selection of a particular channel/signal is accomplished at least in part by the controller 52, which is in communication with the RF front end 42. The controller 52 is operative to provide a control signal to the RF front end 42 for selection of which channel/signal to receive and down convert by the RF front end 42. The controller 52 may be a processor, microprocessor, appropriate circuitry/logic or the like that is operative to provide a signal to the RF front end 42 to selectively capture or tune to a particular channel/signal of the RF input. The particular channel/signal being obtained by the RF front end 42 is the channel to be tested (the channel under test).

The selected channel IF signal is then fed or input to the bandwidth selector 44. The bandwidth selector 34 is operative via appropriate circuitry/logic to select an appropriate bandwidth (frequency range) of the useful components for the selected channel/signal. The appropriate bandwidth is according to whatever digital standard (i.e. ITU-T J.83 Annex A, Annex B, Annex C, etc.) is being utilized by the CATV system 10. For an Annex B CATV system 10, the bandwidth is 6 MHz, while the bandwidth for an Annex A system 10 approximately is 7 or 8 MHz. Selection of the appropriate bandwidth is initiated by the controller 52 that is in communication with the bandwidth selector 44. The controller 52 is operative to provide a control signal to the bandwidth selector 44 for passing the selected bandwidth of the television channel to the converter 46.

Once the appropriate bandwidth or digital standard has been selected, an IF bandwidth output signal is fed or input to the converter 46. The converter 46 is operative via appropriate circuitry/logic to convert the IF bandwidth output signal from the bandwidth selector 44 into a baseband signal (or alternatively worded, to recover the modulated information from a carrier component of the IF bandwidth output signal). The baseband signal from the converter 46 is then fed or input into the digital modulation decoder (demodulator) 48.

The digital modulation decoder 48 is operative via appropriate circuitry/logic to selectively apply a demodulator or modulation decoder to recover the original television bitstream or information from the RF input signal. The digital demodulation decoder 48 is operative to apply a demodulator of any one of various digital modulation schemes such as QAM, VSB, and QPSK, and their variants. The demodulator (demodulation scheme) used by the demodulation circuitry/logic 48 depends on the modulation scheme employed by the CATV system under test. Selection of the appropriate demodulator is initiated by the controller 52 that is in communication with the digital modulation decoder 48. The controller 52 is operative to provide a control signal to the digital modulation decoder 48 for selection and application of the demodulator to the baseband television channel/signal.

The digital modulation decoder 48 may include demodulation circuitry/logic for all known types of modulation schemes for the digital channel. As well, the digital modulation decoder 48 may have only one type of demodulation circuitry for a specific type of modulation scheme such as QAM and its variants (i.e. 64-QAM, 256-QAM). The test meter 40 thus demodulates the RF input signal to obtain a digital bitstream of the television channel. For a television signal, the digital bitstream information includes both video and audio information (a composite bitstream), and any other secondary information (such as closed captioning or ratings information). Various parameters of the digital bitstream and/or the baseband signal may thus be analyzed. Analyzed results are provided as output 50.

Referring to FIG. 5, there is depicted another embodiment of a test meter, generally designated 60, in accordance with the principles presented herein. The test meter 60 is operative to receive an input signal in like manner as the test meter 30 of FIG. 2. Particularly, the test meter 60 is operative to be coupled to a point in the coaxial cable 18 of the CATV system 10 in order to obtain an RF input signal. The RF input signal consists of a plurality of television channels at least one of which is a digital television channel and/or other digital signals. The test meter 60 is operative to analyze various parameters of the digital signal under control of a user.

On an elementary level, the test meter 60 includes an RF front end module, section or portion 62 to which the RF input signal is coupled. The RF front end 62 includes a tuner 64 that is operative to tune or select a particular digital television channel or signal from the plurality of digital signals, and a down converter 66 that is operative to down convert the selected or tuned digital signal to an intermediate frequency (IF) signal. A bandwidth or digital standard selector module, section or portion 68 is in communication with the RF front end 62 so as to receive the IF output signal from the RF front end 62. The bandwidth selector module 68 includes various signal conditioning circuitry operative to apply a selected digital standard from multiple digital standards. In particular, the bandwidth selector module 18 has a first filter (Filter 1) or the like and a second filter (Filter 2) of the like each of which is operative to pass a particular range of frequencies corresponding to a particular digital standard. It should be appreciated that the number of filters of the bandwidth selector 68 may be greater depending on the number of digital standards the test meter 60 is designed to accommodate. In the form shown in FIG. 5, the bandwidth selector is operative to select and/or apply one digital standard between two possible digital standards or bandwidths (i.e. one of the two filters).

A converter module, section or portion 74 is in communication with the bandwidth selector 68 so as to receive an output (output signal) from the bandwidth selector 68. A digital modulation decoder (digital demodulator) and data acquisition module, section or portion 76 is in communication with the converter 74 so as to receive an output (output signal) from the converter 74. Alternatively, the output of the bandwidth selector 68 may be input directly to the digital modulation decoder and data acquisition module 76. A controller 78 is in communication with the RF front end 62, the bandwidth selector 68 and the digital modulation decoder and data acquisition section 76 so as to provide control signals to the respective sections. A data line 79 is provided between the controller 78 and the digital demodulator and data acquisition section 76 for exchanging data therebetween. A use interface 80 is in mutual communication with the controller 78. The user interface 80 may take any form such as a graphical user interface (GUI), buttons, and/or a combination thereof. The user interface 80 allows the user to make appropriate choices and/or selections regarding use and/or operation of the test meter 60 and allow the display of various results, choices/selections, and/or the like.

In particular, the RF front end 62 is operative via the tuner 64 to selectively receive or tune to any particular digital channel/signal of the RF input signal as selected by the user via the user interface 80. Selection of a particular digital signal by the user via the user interface 80 causes the controller 78 to provide a tuning signal to the tuner 64 for appropriate tuning of the RF input signal. The tuned is then input to the downconverter 66, which down converts the selected channel/signal to an intermediate frequency (IF) signal.

The selected channel IF signal is then fed or input to the bandwidth selector 68. The bandwidth selector 68 is operative via appropriate circuitry/logic to select an appropriate bandwidth (frequency range) of the useful components for the selected channel/signal. The appropriate bandwidth is according to whatever digital standard (i.e. ITU-T J.83 Annex A, Annex B, Annex C, etc. ) is being utilized by the CATV system 10. For an Annex B system 10, the bandwidth is approximately 6 MHz, while the bandwidth for an Annex A system 10 is approximately 7 or 8 MHz. One of the two filters 70 (Filter 1) and 72 (Filter 2) is operative to pass one bandwidth (i.e. digital standard) while the other of the filters 70 and 72 is operative to pass another bandwidth (i.e. digital standard). The controller 78, under the control of the user via the user interface 80, provides a standard selection signal to the bandwidth selector 68 in order for the bandwidth selector 68 to select an appropriate digital standard. In one form, the filters 70 and 72 are appropriately configured SAW filters.

A selected filtered digital television signal from the bandwidth selector 68 is input to the converter 74. The converter 74 recovers or extracts a baseband digital television signal from the filtered television signal. The digital baseband television signal is input to the digital modulation decoder 76. The digital modulation decoder applies a digital demodulation scheme (e.g. QAM and/or its variants) according to the type of digital modulation scheme of the digital television channel of the RF input signal. The selection of the digital modulation decoder to apply to the baseband digital television signal to recover the original bitstream of the digital television channel is provided by the user via the user interface 80 through the controller 78. In addition, the digital demodulator 76 performs data acquisition in conjunction with the controller 78 to provide raw and analyzed data to the user interface 80. In one form, the digital demodulator and data acquisition 76 is performed by a universal QAM integrated circuit (IC or chip) such as a Broadcom BCM 3125. The user interface 80 allows the user to select the appropriate standards and/or formats in order for the test meter 60 to properly analyze various parameters of the digital television channel/signal.

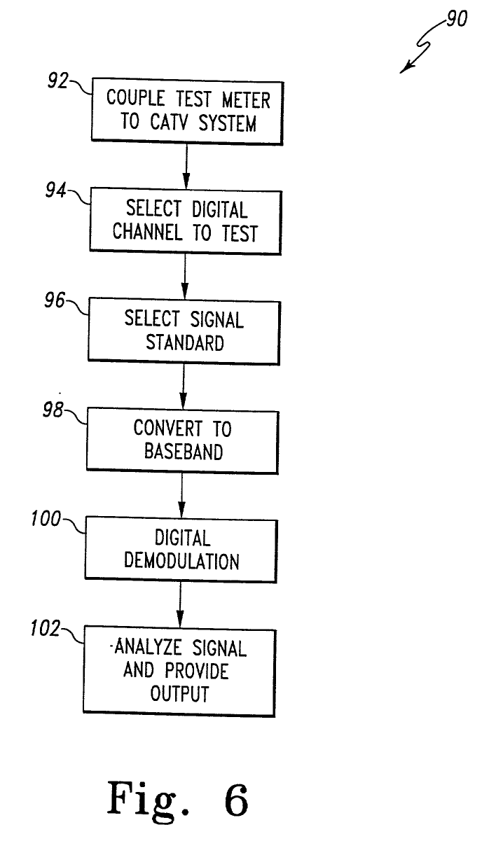

Referring now to FIG. 6, there is depicted a flow diagram, generally designated 90, illustrating an exemplary manner of operation of any one of the test meters hereinbefore discussed. In the present case, the test meter 60 of FIG. 5 will be used as the exemplary test meter. Initially, in step 92, the test meter (30, 40, or 60) is coupled to a point in the television signal distribution network (e.g. CATV system 10) so as to receive an RF input signal. In step 94, the user selects a digital television channel or signal for testing which is then selected via the RF front end 42 and downconverted into an intermediate frequency (IF) digital television signal. In step 96, the user selects an appropriate digital standard (e.g. Annex A, Annex B, Annex C, or the like) or bandwidth for the selected digital television channel which is accomplished by the bandwidth selector 44. This will typically be the digital standard for all of the digital television channels of the CATV system 10.

In step 98, the bandwidth selected digital television IF signal is then converted into a digital television baseband signal by the converter 74. In step 100, the digital television baseband signal is digitally demodulated by the digital demodulator 76 according to the digital demodulation scheme selected by the user via the user interface 80 and implemented by the digital demodulator 76 in order to yield digital information. In step 102, data regarding various analyzed parameters of the digital bitstream are provided to the user interface 80.

While this invention has been described as having a preferred design and/or configuration, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A test meter for a digital signal distribution system comprising:
a front end operative to acquire a digital signal carried by the digital signal distribution system;
signal conditioning circuitry in communication with said front end so as to receive the acquired digital signal and operative to apply signal conditioning to the digital signal according to any one of a plurality of digital standards; and
a digital demodulator in communication with said signal conditioning circuitry and operative to apply any one of various digital demodulation decoding schemes to obtain a demodulated signal.

2. The test meter of claim 1, wherein the plurality of digital standards comprise ITU-T J.83 Annex A, Annex B, and Annex C and the various digital demodulation decoding schemes comprise QAM and QAM variants.

3. The test meter of claim 1, wherein said signal conditioning circuitry comprises a first filter and a second filter.

4. The test meter of claim 3, wherein said first filter comprises a SAW filter operative to filter a first bandwidth according to a first digital standard, and said second filter comprises a SAW filter operative to filter a second bandwidth according to a second digital standard.

5. The test meter of claim 4, wherein said first digital standard comprises ITU-T J.83 Annex A and said second composite color standard comprises ITU-T J.83 Annex B.

6. The test meter of claim 5, further comprising a user interface operative to allow a user to select any one of the plurality of digital standards.

7. The test meter of claim 1, wherein said digital demodulator is operative to apply any selected one of various digital demodulation decoding schemes to said digital standard signal to obtain a demodulated signal.

8. The test meter of claim 7, wherein said test meter further includes a user interface operative to allow a user to select any one of the various digital demodulation decoding schemes.

9. The test meter of claim 8, wherein the various digital demodulation decoding schemes comprises QAM and QAM variants.

10. A test meter for a digital cable television system comprising:
a front end operative to obtain a digital television signal from a point in the digital cable television system;
signal conditioning circuitry in communication with said front end so as to receive the obtained digital television signal and operative to selectively apply signal conditioning to said obtained digital television signal according to any one of multiple digital standards to obtain a digital standard signal;
a digital demodulator in communication with said signal conditioning circuitry so as to receive said digital standard signal and operative to selectively apply any one of multiple digital demodulation schemes to obtain a demodulated signal; and
selection circuitry in communication with said signal conditioning circuitry and said digital demodulator and operative to select a digital standard of the multiple digital standards for application by said signal conditioning circuitry and to select a digital demodulation scheme of the multiple digital demodulation schemes for application by said digital demodulator.

11. The test meter of claim 10, wherein said selection circuitry comprises a user interface operative to allow user selection of the various selections.

12. The test meter of claim 12, wherein said signal conditioning circuitry comprises a filter for each of the multiple digital standards.

13. The test meter of claim 12, wherein said signal conditioning circuitry comprises a first filter corresponding to a first digital standard and a second filter corresponding to a second digital standard.

14. The test meter of claim 13, wherein said first filter is a SAW filter corresponding in bandwidth to an ITU-T J.83 Annex A digital standard, and said second filter is a SAW filter corresponding in bandwidth to a an ITU-T J.83 Annex B digital standard.

15. The test meter of claim 10, wherein the multiple digital demodulation decoding schemes comprises QAM and QAM variants.

16. A method of analyzing a digital signal carried by a digital signal distribution system, comprising:
coupling a test meter to a point in the digital signal distribution system;
obtaining via the test meter a digital signal carried by the digital signal distribution system;
selecting via the test meter a digital standard from multiple digital standards to apply to the obtained digital signal;
applying via the test meter the selected digital encoding standard to the signal to obtain a digital standard signal;
selecting via the test meter a demodulation scheme from multiple demodulation schemes to apply to the digital standard signal; and
applying via the meter the selected demodulation scheme to the digital standard signal to obtain a demodulated signal for analyzing of various parameters thereof.

17. The method of claim 16, wherein the multiple digital standards comprise ITU-T J.83 Annex A, Annex B, Annex C.

18. The method of claim 16, wherein the multiple demodulation schemes comprise QAM and QAM variants.

19. The method of claim 16, wherein the selecting steps are performed via a user interface.
